(19) United States
(12) Patent Application Publication
(10) Pub. No.: US 2010/0225538 A1
(43) Pub. Date: Sep. 9, 2010

(54) Frequency Mode Of Locking Phased Arrays For Synthesizing High Order Traveling Interference Patterns

(75) Inventor: Oved ZUCKER, Annandale, VA (US)

Correspondence Address: BAE SYSTEMS, PO BOX 868, NASHUA, NH, 03061-0868, US

(73) Assignee: BAE Systems Information and Electronic Systems Integration Inc., Nashua, NH (US)

(21) Appl. No.: 12/781,153

(22) Filed: May 17, 2010

Related U.S. Application Data
(63) Continuation of application No. 11/446,266, filed on Jun. 5, 2006, now abandoned.

(51) Int. Cl. H01Q 3/00

(52) U.S. Cl. 342/372

(57) ABSTRACT

The elements of a phased array antenna are driven by different frequencies, rather than the same frequency, to realize a scanning beam. The scan rate of the beam may be set arbitrarily high according to the frequencies used to drive the phased array, without expensive phase modulators. In particular, each successive element of the phased array antenna is driven with a frequency that is offset from the frequency used to drive the previous element in direct proportion to the spacing between antenna elements. Thus, for a straight line implementation of a phased array antenna with an antenna spacing offset of λ/2, the frequency offset between adjacent antenna elements is constant. For implementations of phased array antennas with another linear or a non-linear spatial relationship between antenna elements, the frequency offset between adjacent antenna elements is determined based on a linear or non-linear spatial relationship of the antenna.

### FIELD OF THE INVENTION

The present invention relates to antennas and, more particularly, to a frequency mode of locking phased arrays for synthesizing high order traveling interference patterns.

### BACKGROUND OF THE INVENTION

Phased array antennas have been used for many years to allow electronic scanning. In general, a phased array antenna operates by feeding a set of radiating elements (a planar array) with phase shifters in such a way that the phase variations along the array follow an arithmetic progression whose common difference is the phase shift between two adjacent elements. The phased array so configured generates a plane wave whose direction depends on this phase difference. While some phase shifters described above, still others are active and incorporate amplifiers.

Phased array antennas are useful for a variety of applications. One desirable application of phased array antennas is in the implementation of steerable beams for communications, RADAR, remote monitoring and other applications. Phase array antennas are desirable for steerable beam applications because they can be electronically stimulated to cause the same fixed antenna elements to produce beams that have different shapes and that point in different directions. Thus, they provide a high degree of flexibility in their configuration.

Conventionally, phased arrays have been configured as shown in FIG. 1. Each phased array antenna includes a plurality of antenna elements designed to operate at a particular center frequency (f₀). The antenna elements are generally situated in an array with a constant spacing determined by the wavelength at the center frequency divided by two (λ/2). The antenna elements are driven by feeder circuitry which is designed to impart a different phase shift on each antenna element in order to realize a desired antenna characteristic. The characteristic might be a different pointing direction, a different beam shape, or a traveling beam.

In the case of a traveling beam implemented with a traditional phased array antenna, all of the antenna elements are driven by a signal having the same frequency, and each antenna element is driven with a certain phase offset (ΔΦ) relative to the other antenna elements of the phased array to realize the traveling beam. The feeder circuitry shown in FIG. 1 is used to generate the phase offset used to drive each antenna element. A problem with the conventional phased array system is that the feeder circuitry is very expensive, comprising up to forty percent of the overall cost of a system. The cost is directly proportional to the desired travel rate of the beam and increases with the travel rate. Moreover, the circuitry required to generate proper phase offsets is complex and limits the travel velocity or scan rate of the beam.

Accordingly, there is a need to have phased array antenna design that permits high rates of beam travel at a reasonable cost. There is a further need to implement phased array antennas that permit very high scanning performance.

### SUMMARY OF THE INVENTION

According the present invention, the elements of a phased array antenna are driven by different frequencies, rather than the same frequency, to realize a scanning beam. The scan rate of the beam may be set arbitrarily high according to the frequencies used to drive the phased array, without expensive phase modulators. In particular, each successive element of the phased array antenna is driven with a frequency that is offset from the frequency used to drive the previous element in direct proportion to the spacing between antenna elements. Thus, for a straight line implementation of a phased array antenna with an antenna spacing offset of λ/2, the frequency offset between adjacent antenna elements is constant.

For implementations of phased array antennas with another linear or a non-linear spatial relationship between antenna elements, the frequency offset between adjacent antenna elements is determined based on the linear or non-linear spatial relationship of the antenna elements. Using this implementation, the phase offset between antenna elements becomes a function of time, as opposed to a function of the physical structure of the antenna, and produces a beam sweep without expensive phase generation electronics.

According to an embodiment of the invention, a modulated signal may be applied to the phased array antenna to convey information. In addition, the frequency offset may be adjusted to vary a scan rate of the beam.

### BRIEF DESCRIPTION OF THE FIGURES

The present invention will be more fully appreciated with reference to the following detailed description and appended drawing figures, in which:

FIG. 1 depicts a phased array antenna system according to the prior art.

FIG. 2 depicts a phased array antenna system according to an embodiment of the present invention.

FIG. 3 depicts an illustration of a scanning beam produced with a phased array antenna according to an embodiment of the present invention.

FIG. 4 depicts an implementation of a frequency offset feeder unit according to an embodiment of the present invention.

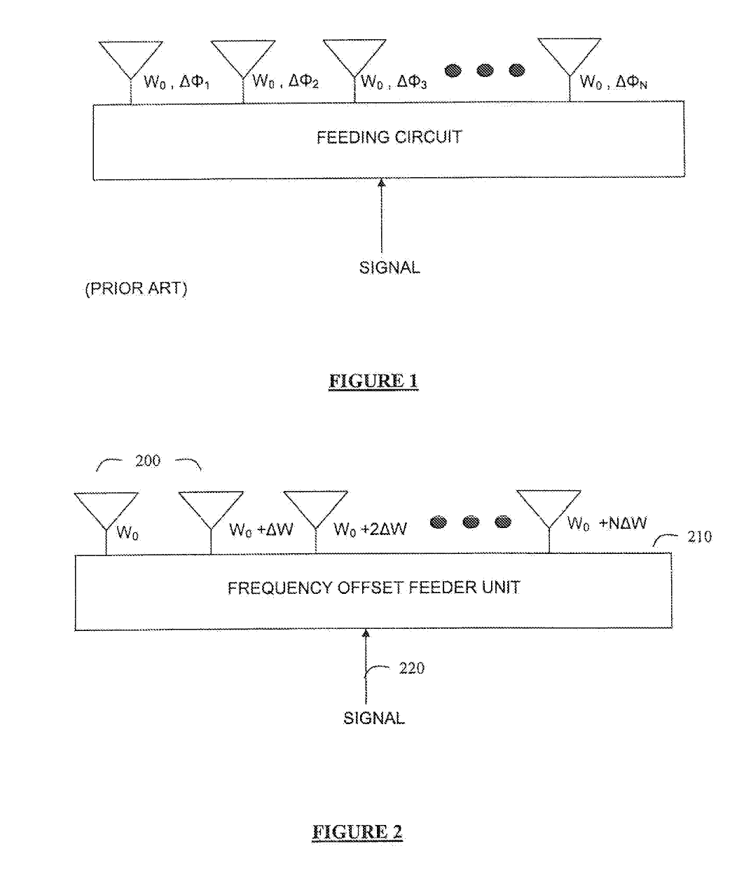

### DETAILED DESCRIPTION

According the present invention, the elements of a phased array antenna are driven by different frequencies, rather than the same frequency, to realize a scanning beam. The scan rate of the beam may be set arbitrarily high according to the frequencies used to drive the phased array, without expensive phase modulators. In particular, each successive element of the phased array antenna is driven with a frequency that is offset from the frequency used to drive the previous element in direct proportion to the spacing between antenna elements. Thus, for a straight line implementation of a phased array antenna with an antenna spacing offset of λ/2, the frequency offset between adjacent antenna elements is constant.

FIG. 2 depicts a phased array antenna system for transmitting signals according to an embodiment of the present invention. Referring to FIG. 2, the phased array antenna includes antenna elements 200, which are offset from each other with a constant spacing, for example λ/2. It will be understood, however, that any separation distance that may be used to implement a phased array antenna may be used according to the present invention. Each element of the phased array is fed by a frequency offset feeder unit 210, which is in turn coupled to a signal 220. The frequency offset feeder unit 210 generates a plurality of signals for each antenna element 200. For example, when N elements are present, the first antenna element may be driven at an angular frequency of w₀. Each adjacent element may be driven at an angular frequency of w₀+(Element number up to N−1)*Δw, where Δw is the frequency offset between adjacent elements.

The frequency offset may be determined according to the desired sweep rate for the antenna. The antenna sweep rate is equal to Δw. The frequency, Δw, should be chosen so that Δw is much less than w₀. For example, Δw is preferably at least five times less than w₀, and typically may be anywhere from one to five orders of magnitude less than w₀. It will be understood, however, that any value of Δw may be used according to the present invention without limitation to the ranges identified above according to the desired characteristics of the system.

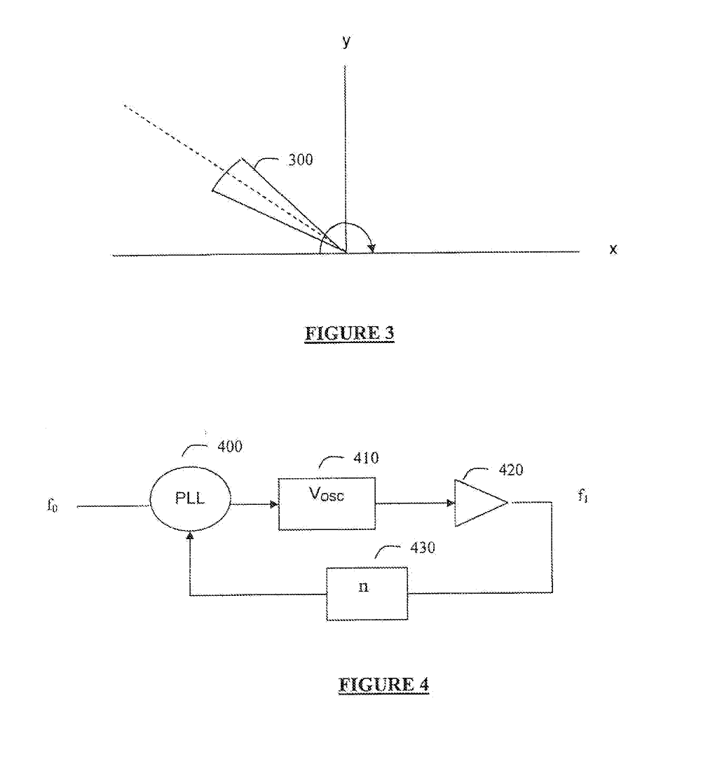

FIG. 3 depicts an illustration of a scanning beam produced with a phased array antenna according to the phased array antenna shown in FIG. 2. Referring to FIG. 3, a beam 300 is produced that rotates across its full steerable range at the rate of the frequency offset. For a phased array with n antenna elements, the beam width of the beam is considered to be the 3 dB range. For a phased array antenna having a baseline frequency, w₀, of 10 GHz and thirty antenna elements spaced apart at λ/2 increments and having a frequency offset of 1 MHz, the beam will sweep across its full steerable range at a rate of 1 MHz. When modulation is present, the signal may have a center frequency of w₀ and a bandwidth around w₀ representing the signal.

The frequency offset feeder unit 210 may be implemented in many different ways. One way is shown in FIG. 4. Referring to FIG. 4, the frequency offset feeder unit may be implemented with a phase locked loop 400, a voltage controlled oscillator 410 and an amplifier 420. The phase locked loop receives an input frequency, f₀, that may be, for example, the frequency of the center element of the phase locked loop. It will be understood, however, that f₀ may reflect the frequency of any of the elements or may be a frequency that is used for timing purposes only.

The frequency f0 is enters the phase locked loop 400 and travels through a voltage controlled oscillator 400 used to adjust the frequency of the input signal according to a desired function. The VCO may, for example, multiply or divide the frequency by a constant value n. The frequency output from the VCO, f1, may then be amplified by an amplifier and transmitted to an individual antenna element. The output signal, f1, is then fed multiplied or divided by the same constant n used by the VCO and this output is fed back into the phase locked loop. In this manner, an output frequency, f₁, is produced that is in phase with the input frequency f₀. Arrays of this type of circuit may be implemented to generate multiple signals at specific frequencies according to a desired function that are each in phase with f₀. Other techniques may be used to implement the frequency offset feeder unit.

While particular embodiments of the present invention have been shown and described, it will be understood by those having ordinary skill in the art that changes may be made to those embodiments without departing from the spirit of the present invention.

What is claimed is:

1. An antenna system, comprising:
a phased array antenna having a plurality of elements; and
a frequency offset feeder unit for feeding at least some of the elements at different frequencies, wherein the difference in frequencies is proportional to a difference in spacing between the at least some antenna elements.

2. The antenna system according to claim 1,
wherein the antenna elements are uniformly spaced apart; and
wherein the difference in frequencies is a frequency offset between adjacent elements.

3. The antenna system according to claim 1,
wherein the antenna elements are spaced apart according to a linear function; and
wherein the difference in frequencies between adjacent elements is proportional to the linear function.

4. The antenna system according to claim 1,
wherein the antenna elements are spaced apart according to a non-linear function; and
wherein the difference in frequencies between adjacent elements is proportional to the non-linear function.

5. The antenna system according to claim 1, wherein the frequency offset feeder unit generates the different frequencies in phase with one another.

6. The antenna system according to claim 5, wherein the frequency offset feeder unit incorporates a plurality of phase locked loops and voltage controlled oscillators that generate the different frequencies from a baseline signal.

7. An method of operating a phased array antenna system having spaced antenna elements, comprising:
generating a plurality of different frequencies, comprising a first frequency and a series of additional frequencies, each frequency being associated with one of the antenna elements and wherein the difference in frequencies is proportional to a difference in spacing between each antenna element; and
applying the frequencies to the respective antenna elements to generate a beam.

8. The method according to claim 7,
wherein the antenna elements are uniformly spaced apart.

9. The method according to claim 7,
wherein the antenna elements are spaced apart according to a linear function; and
wherein the difference in frequencies between adjacent elements is proportional to the linear function.

10. The method according to claim 7,
wherein the antenna elements are spaced apart according to a non-linear function; and
wherein the difference in frequencies between adjacent elements is proportional to the non-linear function.

11. The method according to claim 7, wherein the different frequencies are generated in phase with one another.

12. The method according to claim 11, wherein the different frequencies are generated based on a plurality of phase locked loops and voltage controlled oscillators that generate the different frequencies from a baseline signal.

13. The method according to claim 7, further comprising:
applying a modulated signal to the antenna elements to convey information through the beam.

14. The method according to claim 7, further comprising adjusting the difference in frequency to vary a scan rate of the beam.
